(19) United States
(12) Patent Application Publication
(10) Pub. No.: US 2007/0257562 A1
(43) Pub. Date: Nov. 8, 2007

(54) Linear Drive Unit with an Oscillating Armature Part and a Spring

(75) Inventors: Johannes Reinschke, Nurnberg (DE); Gunter Ries, Erlangen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 10/591,089

(22) PCT Filed: Mar. 7, 2005
(86) PCT No.: PCT/EP05/51007

§ 371 Date: May 21, 2007

(30) Foreign Application Priority Data
Mar. 5, 2004 (DE) 10 2004 010 849.8

(51) Int. Cl. H02K 41/00

(52) U.S. Cl. 310/12

(57) ABSTRACT

A drive unit contains an exciter winding, an magnetic armature part which is set into an oscillating vibration movement, by the magnetic field of the winding, about a center position in an axial direction and at least one spring which is clamped in a fixed manner in a clamping position and whose oscillating end engages with the armature part, acting in the direction of movement. In the center position of the armature part, the point of engagement of the spring with the armature part is axially offset by a predetermined distance in relation to the clamping position in order to appropriately offset the armature part when in a rest position.

The invention relates to a linear drive unit
comprising at least one exciter winding,
comprising a magnetic armature part which is set in linear oscillating motion about a centre position in an axial direction by the magnetic field of the winding, and
comprising at least one spring which is clamped in a fixed manner and whose oscillating end acts on the armature part in the direction of motion.

A corresponding drive unit is deduced from JP 2002-031054 A.

Corresponding drive units are used in particular to set pump plungers of compressors in linear oscillating motion. The system comprising such a compressor and a linear drive unit is therefore also designated as a linear compressor (see the JP-A specification mentioned initially).

In corresponding known linear compressors, the armature part provided with leaf springs which are generally circular-disk-shaped (see the JP-A specification mentioned initially) forms a spring-mass system with a certain characteristic oscillation frequency. If the linear compressor is to oscillate at 50 Hz (i.e. at the mains frequency), according to the conventional prior art, the spring constant of the two leaf springs would be designed in conjunction with the armature mass such that the characteristic frequency of the spring-mass system is 50 Hz. Furthermore, the rest position of the springs corresponds to the centre position of the desired armature oscillation. During operation a linear compressor thus designed delivers only a limited efficiency and displays a relatively slow start-up behaviour.

It is thus the object of the present invention to improve the linear drive provided with the aforementioned features such that it has a comparatively higher efficiency compared with the prior art and allows easier and more rapid start-up.

In order to achieve this object, the linear drive unit comprises the features specified in claim 1. Accordingly, in the centre position of the armature part, the point of application of the spring on the armature part is displaced axially by a predetermined distance in relation to its clamping position. The centre position of the armature part is understood in this case to be the position of the armature part which this adopts during its oscillation phase between its two maximum lateral deflections.

When the armature part is located in its rest position, this is then displaced towards one side compared with the centre position as a result of the given pre-stressing of the spring.

The advantages associated with this embodiment of the drive unit are seen in particular in the lower electrical losses, a higher efficiency, and the fact that the armature movement is easier to control and regulate. In addition, the start-up properties of the drive unit are thus improved.

Advantageous embodiments of the drive unit according to the invention are deduced from the dependent claims. At the same time, the embodiment according to claim 1 can be combined with the features of one of the dependent claims or preferably with those of a plurality of dependent claims. Accordingly, the following features can additionally be provided for the drive unit:
The at least one spring can be configured in particular as a leaf spring clamped transverse to the direction of movement of the armature part.
In addition, a plurality of springs can be provided on both sides of the centre position. In particular, when using leaf springs, it is thus possible to retain and guide the armature part.
Furthermore, the armature part can advantageously be connected to at least one pump plunger of a compressor, wherein the axial displacement of the point of application of the at least one spring on the armature part is provided in the direction leading away from the compressor. This measure specifically improves the start-up properties of the system comprising armature part and plunger.
Springs having low spring constants or stiffness can particularly advantageously be used. Springs constructed in this manner are particularly suitable for the displacement of its points of application on the armature part according to the invention.
The axial displacement of the point of application of the at least one spring is preferably selected depending on its spring constants.
In addition, it can be regarded as particularly advantageous if the spring constant of the at least one spring is selected such that the characteristic frequency of the drive unit in cooperation with the total oscillating mass is lower than the frequency of the driving magnetic force.

Further advantageous embodiments of the drive unit according to the invention are obtained from the claims not discussed previously and the drawings.

The invention is explained in detail hereinafter with reference to the drawings. In the figures:

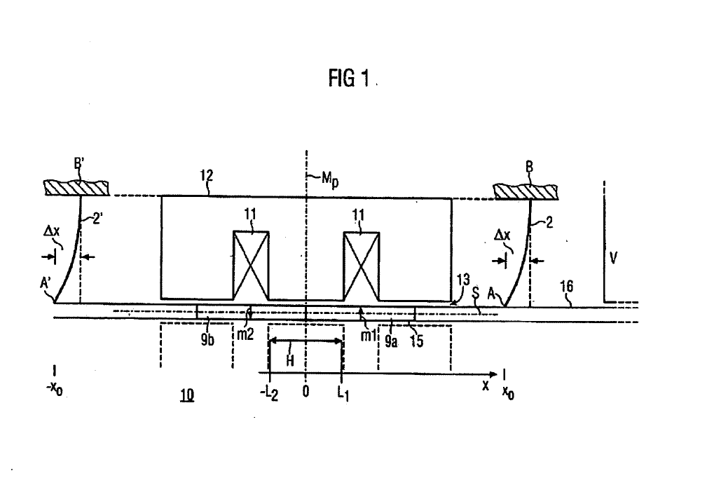

FIG. 1 is a schematic diagram showing the upper part in relation to an axis of symmetry of a cross-section through the drive unit according to the invention,

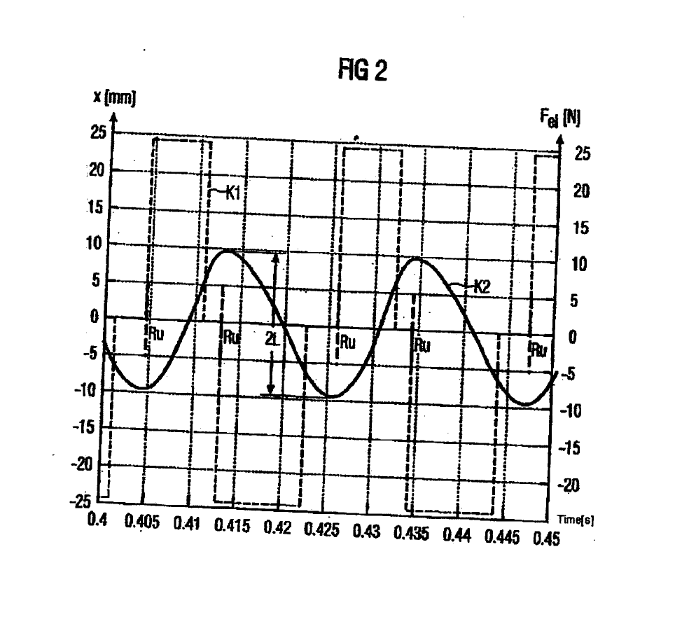

FIG. 2 shows the armature movement and electrically influenced force in such a drive unit and

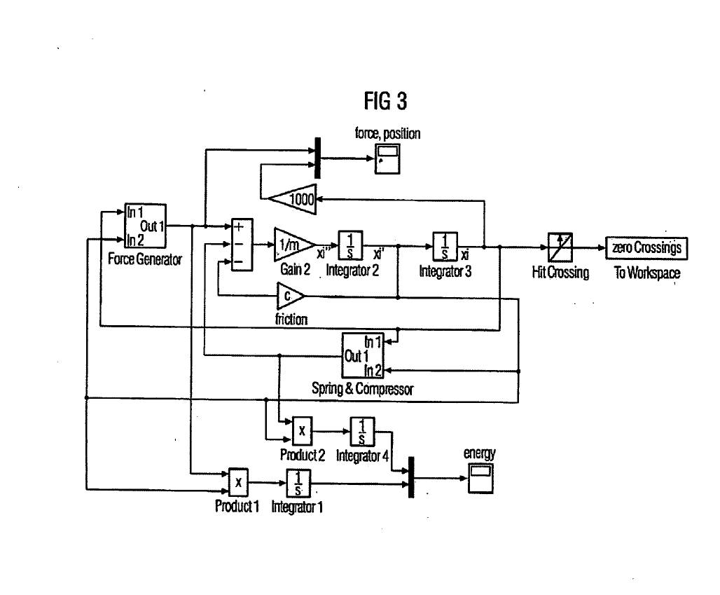

FIG. 3 shows a simulated structure for designing springs.

Springs known per se, which act in the direction of oscillation/movement of its armature part can be used for the rive unit according to the invention. It appears particularly suitable to use at least one spring, preferably two leaf springs. These leaf springs are selected for the following exemplary embodiment. They make it possible to nevertheless achieve sufficiently good lateral stabilisation or retaining of the oscillating armature part perpendicular to its direction of movement with a low stiffness or spring constant k in the direction of oscillation/movement perpendicular to the plane of the spring. Naturally, other types of springs such as helical or coil springs can also be used. Bearings can also be provided in a known manner for lateral guidance.

FIG. 1 substantially shows schematically only the upper part of a cross-section through a two-part linear drive unit 10 according to the invention; i.e., the figure only shows details of the part of the unit located on one side of an axis of symmetry S which extends in an axial direction of oscillation. Corresponding symmetrically constructed drive units are known per se (see, e.g. U.S. Pat. No. 6,323,568 B1). The drive unit 10 according to the invention comprises at least one exciter winding 11 provided with at least one associated magnetic-flux-carrying yoke body 12. A magnetic armature or armature part 15 is located in a central channel-like opening or a slit-shaped gap 13 of this yoke body. This armature contains two permanent magnets 9a and 9b arranged axially one behind the other, whose oppositely directed directions of magnetisation are indicated by arrowed lines m1 and m2. This armature can execute an oscillating movement in the axial direction in the varying magnetic field of the winding 11, wherein it oscillates about a centre position Mp. The maximum deflection from this centre position in the axial direction x, i.e. the oscillation amplitude is designated by +L₁ or −L₂.

As is further indicated in the figure, the two leaf springs 2 and 2′ which act on extended parts of the armature 15 at points of application A or A′ on both sides of the centre position Mp should be fixed such that they exert a force in the x-direction in the centre position of the armature 15 shown. Here x₀ and −x₀ designate the (initial) positions of the points of application A and A′ of the springs 2 and 2′ under the formation of pre-stressing which are obtained in a symmetrical arrangement of the armature part 15 with its two magnet parts 9a and 9b with respect to the centre position Mp. The spring constant k of the at least one spring is advantageously dimensioned such that the characteristic frequency f₀=

[symbol]

of the drive unit in cooperation with the entire oscillating mass m is lower than the frequency of the driving magnetic force to be produced by the exciter winding. The value of k can be determined by means of computational methods.

In the drive unit according to the invention, the rest position of the armature in which the spring forces are removed, is displaced by a predetermined distance Δx towards one side. The associated pre-tensioning force should act laterally in the x-direction where a compressor V or its pump plunger is located. For this purpose, at least on one side the armature 15 goes over axially into a lateral extension part 16, not embodied in detail, which is rigidly connected to the pump plunger of the compressor V. Corresponding compressors of linear compressors connected to linear drive units and their individual parts belong to the prior art (see, e.g. said JP_{—}2002-031054_A or U.S. Pat. No. 6,323,568 B1). Thus, these will not be described.

FIG. 1 shows the armature 15 at the time when it is located precisely symmetrically to the centre position Mp during its oscillating movement. Consequently, in this position the springs 2 and 2′ which are secured fixedly at fixing points B or B′ are bent by the distance Δx towards the side leading away from the compressor side at their points of application A or A′. This has the result that in the rest position in which the spring forces are not acting, the armature is displaced from its centre position (shown) towards the compressor V.

For the diagram in FIG. 2, a movement of the centre point of the armature 15 between the points x_=_−L₂ and x_=_+L₁ is assumed where L₁ and L₂ are each about 10 mm, for example. As an example, the figure also shows the electrically influenced force Fₑₗ (curve K1) in N and the position x (curve K2) in mm as a function of the time in sec. The positions of reversal of the armature direction are indicated by dashed lines designated as Ru having an increased line width.

Principles of Spring Design of a System Comprising Drive Unit and Compressor

For the following analyses, a linear drive unit 10 is assumed, its armature 15 being connected to a pump plunger of a compressor V. For simplicity it is assumed that
L₁=L₂=L.

The magnitude of the electromagnetic force acting on the armature
Fₑₗ
should either be zero or have a fixed value, the sign of the force always being selected so that the force acts in the direction of movement. The electrical force
Fₑₗ
is only non-zero for a fraction
a
of the distance (
0<a<1
;
a is hereinafter designated as “duty cycle”). Let
k
be the sum of the spring constants in the direction of movement and
x₀
the rest position of the spring with respect to the centre position of the armature.

For

[symbol]

which corresponds to the return travel away from the compressor, the energy supplied electrically to the armature is given by

Table 1 [symbol] [symbol]
Eq. 1

and from the armature dead-centre point
x=+L
to the armature dead-centre point
x=−L
the potential energy of the spring varies by
Table 2 [symbol] [symbol]
Eq. 2

Both energies must be the same, i.e.

Table 3 [symbol] [symbol]
Eq. 3

For

[symbol]

which corresponds to the forward travel towards the armature, the energy supplied electrically to the armature (in turn) is given by

Table 4 [symbol] [symbol]
Eq. 4

and from the armature dead-centre point
x=−L
to the armature dead-centre point
x=+L
the potential energy of the spring varies by

[symbol]

The total electrical energy supplied within an oscillation [symbol] for a constant oscillation amplitude
L
and negligible friction must be equal to the energy used in the compressor
E_{comp.}
The electrical force (assumed to be constant) is thus obtained as
Table 5 [symbol] [symbol]
Eq. 5

If the spring constant
k
and the electrical energy
Eₑₗ₋
(i.e. the electrical force
Fₑₗ
the oscillation amplitude
L
and the duty cycle
a
) are given, the required spring rest position can be calculated by substituting Eq. 1 and Eq. 2 into Eq. 3:

Table 6 [symbol] [symbol]
Eq. 6

From Eq. 6 it can be seen that:

The spring must always be pre-stressed in the positive direction and the pre-stressing distance is shorter, the higher the spring constant
k.

Method for Spring Design

The spring should be designed to that the armature oscillates symmetrically in the yoke with respect to
x=0
(i.e. between
x=−L
and
x=+L
), wherein the frequency
f
of the armature oscillation approximately corresponds to a target value
f_{target}.

For a given armature mass, oscillation amplitude
L
and compressor characteristic, the oscillation frequency
f
is only dependent on two quantities: the spring constant
k
and the duty cycle
a

It holds that:
the larger
   k,
   the greater is
   f
the smaller
   a
   the larger is
   f

The spring can be designed as follows:
1. Specifying the oscillation amplitude
   L
   and determining the compressor energy
   E_{comp}
   under standard conditions where an optimal design of spring is strived for.
2. Specifying the duty cycle
   a
   and calculating the electrical force
   Fₑₗ
   according to Eq. (5) (or calculating the coil current corresponding to the force).
3. Specifying the spring constant
   k
   and calculating the spring rest position
   x₀
   using Eq. 6.
4. Simulating the spring-compressor-mass system assumed for FIG. 3 and determining the oscillation frequency
   f
5. If
   f
   and the target value
   f_{target}
   differ too substantially from one another, return to 2. (change the duty cycle
   a
   ) or 3. (change the spring constant
   k

Example Calculations

The example calculations relate to a known compressor with a stroke of
2L=20
mm and standard pressure conditions (
pₘₐₓ−pₘᵢₙ=(7.7−0.6)
bar). Since the dead volume is assumed to be vanishingly small, it produces no restoring force. The mechanical work performed per oscillation in the compressor under these conditions is 0.7753 J. If the mechanical power should be 40 W, an oscillation frequency of 51.6 Hz is required.

In the simulation block diagram according to FIG. 3,
m
(mass) and
c
(coefficient of friction) have values of 90 g and 0.336 Ns/m.

In the following table the duty cycle
a
and the spring constant
k
should be considered to be initial quantities whereas the electrical force
Fₑₗ
, the spring rest position
x₀
and the oscillation frequency
f

are the results of the calculation.

TABLE 7

| Duty cycle | Spring constant | Electrical force | Rest position | Frequency |
|---|---|---|---|---|
| a | K | Fₑₗ | X₀ | F |
| [-] | [N/mm] | [N] | [mm] | [Hz] |
| 1.0 | 2.50 | 19.4 | 7.8 | 35.2 |
| 0.8 | 2.50 | 24.2 | 7.8 | 40.4 |
| 0.5 | 2.50 | 38.8 | 7.8 | 46.2 |
| 0.7 | 5.00 | 27.7 | 3.9 | 51.0 |

### REFERENCE LIST

2, 2′ Leaf springs
9a, 9b Permanent magnets
10 Drive unit
11 Exciter winding
12 Yoke body
13 Channel-like opening
15 Armature
16 Extension part
M1 Centre line
Mp Centre position
S Axis of symmetry
A, A′ Points of application
m1, m2 Directions of magnetisation
x Axial extension
Δx Displacement
L₁, L₂ Deflections
x₀ Initial position
B, B′ Fixing points
V Compressor
K1, K2 Curves
Fₑₗ Force
Rᵤ Positions of direction reversal

1-6. (canceled)

7. A linear drive unit comprising:
a yoke body having an exciter winding providing a magnetic field;
a magnetic armature part which is set in linear oscillating motion about a center position in an axial direction by the magnetic field of the winding;
a spring having a fixed end clamped in a fixed manner with respect to the yoke body and an oscillating end coupled to the armature part at a point of application and acting on the armature part in the direction of motion; and
wherein in the center position of the armature part, the point of application of the spring on the armature part being displaced axially by a predetermined distance in relation to its clamping position.

8. The drive unit according to claim 7, wherein the spring is configured as a leaf spring tensioned transverse to the direction of movement of the armature part.

9. The drive unit according to claim 7, further comprising a plurality of springs disposed on both sides of the center position.

10. The drive unit according to claim 7, wherein the armature part is connected to a plunger of a compressor, the axial displacement of the point of application of the spring on the armature part being provided in the direction away from the compressor.

11. The drive unit according to claim 7, wherein the spring has a relatively low stiffness.

12. The drive unit according to claim 7, wherein the axial displacement of the point of application of the spring is selected depending on the stiffness of the spring.
